(19) United States
(12) Patent Application Publication
(10) Pub. No.: US 2003/0034294 A1
(43) Pub. Date: Feb. 20, 2003

(54) Non-fouling epoxy resin system for permeate carrier reverse osmosis membrane

(76) Inventors: Floyd Greene Dutton, Polkton, NC (US); Victor Alvin Baynard, Wadesboro, NC (US)

Correspondence Address: W. Thad Adams, III, Adams, Schwartz & Evans, P.A., 2180 Two First Union Center, Charlotte, NC, 28282, US

(21) Appl. No.: 09/866,128

(22) Filed: May 25, 2001

(51) Int. Cl. B01D 63/00

(52) U.S. Cl. 210/321.83; 210/506; 210/489

(57) ABSTRACT

A fouling-resistant permeate carrier for a reverse osmosis element, including a tricot knitted fabric and a resin system coated onto the knitted fabric, said resin system including a bisphenol-A/epichlorohydrin-based epoxy resin dispersion, a low molecular weight solid epoxy resin derived from a liquid epoxy resin, bisphenol-A, and a polymeric solid epoxy resin possessing an average epoxide group functionality of 8, a dispersant, a dicyandimide curing agent, a tertiary curing agent, and water for controlling the total percent of nonvolatiles. The dicyandimide may be 4.7-6.5 parts per hundred dicyandiamide and 1.5 parts per hundred of the tertiary curing agent.

### TECHNICAL FIELD AND BACKGROUND OF THE INVENTION

This invention relates to a non-fouling epoxy resin system for a permeate carrier working in conjunction with a reverse osmosis membrane. Such devices are used in many applications to purify water and other liquids. Low pressure systems are used to purify fresh water, while high pressure systems are used to purify sea water by removing the salt. Other applications include concentrating aqueous solutions.

Such systems frequently use a tricot knitted fabric as a permeate carrier which is placed against a selectively permeable membrane. Tricot knitted fabric has been found to be a particularly desirable structure for supporting the membrane material due to the porous knitted structure and raised rows of stitches which define between them long, continuous passageways akin to corrugations through which the liquid being filtered flows. A simplex fabric may also be used.

An epoxy is coated onto the fabric to harden it sufficiently to prevent the fabric from collapsing during use. The tricot is placed with an overlying membrane and formed into a spiral-wound roll on a mandrel. The resulting roll may have for example, 40 layers of the tricot/membrane combination. Liquid is passed from the outside of the roll to the inside, with the purified liquid exiting through a tube in the center of the roll.

A prior art “Bisphenol-A” epoxy resin system was developed by applicant in 1979, and has been applied to tricot and simplex fabrics since that time for use in spiral-wound membrane elements across a wide variety of end uses, generally as described above. This system, which has been the industry-accepted standard for twenty years, has a limiting factor arising out of the fact that during use an unidentified chemical leaches out of the epoxy coated fabric into the permeate stream. While this leachate is non-toxic and quite inert, in a two-pass filtration system, where the permeate of one element is used as the feed stream of another downstream from it, the second membrane becomes partially fouled, or blinded, by it. The pore structure of the downstream element's membrane is “fouled” almost immediately to the extent that it loses up to 50% of its flux, or throughput capacity.

Prior art systems are typically over-designed in order to overcome the degradation in performance due to membrane fouling. In addition, the water used to test and certify all elements after their production cannot be recirculated and reused, thereby incurring significant cost penalties and excessive water usage by the manufacturers of the elements. Also, seawater elements, which in many cases operate at elevated temperatures, suffer similar degradation in performance.

The novel system described in this application reduces the fouling level from the typical 50% down to approximately 5%, or a reduction of 90%. As a result of the invention disclosed herein, reverse osmosis systems are now possible with no serious degradation in performance due to fouling. Test water can be reused and therefore not “dumped.” Seawater elements examined during initial testing and experimentation exhibit dramatically improved performance.

### SUMMARY OF THE INVENTION

Therefore, it is an object of the invention to provide a permeate carrier which exhibits significantly reduced fouling.

It is another object of the invention to provide a permeate carrier which permits a two-pass reverse osmosis system to operate with significantly greater efficiency.

It is another object of the invention to provide a permeate carrier which permits greater efficiency while using conventional, industry-accepted structural filter designs.

It is another object of the invention to provide a permeate carrier which need not be overdesigned in order to overcome filtration degradation.

These and other objects of the present invention are achieved in the preferred embodiments disclosed below by providing a fouling-resistant permeate carrier for a reverse osmosis element, comprising a tricot knitted fabric and a resin system coated onto the knitted fabric, said resin system comprising a bisphenol-A/epichlorohydrin-based epoxy resin dispersion, a low molecular weight solid epoxy resin derived from a liquid epoxy resin, bisphenol-A, and a polymeric solid epoxy resin possessing an average epoxide group functionality of 8, a dispersant, a dicyandimide curing agent, a tertiary curing agent, and water for controlling the total percent of nonvolatiles.

According to one preferred embodiment of the invention, the dicyandimide comprises 4.7-6.5 parts per hundred dicyandiamide and 1.5 parts per hundred of the tertiary curing agent.

According to another preferred embodiment of the invention, the low-molecular weight solid epoxy resin and the polymeric solid epoxy resin each contain an average of 56 percent nonvolatile materials.

An embodiment of the method of forming a fouling-resistant permeate carrier for a reverse osmosis element according to the invention comprises the steps of providing a tricot knitted fabric, coating a resin system onto the knitted fabric, said resin system comprising a bisphenol-A/epichlorohydrin-based epoxy resin dispersion, a low molecular weight solid epoxy resin derived from a liquid epoxy resin, bisphenol-A, and a polymeric solid epoxy resin possessing an average epoxide group functionality of 8, a dispersant, a dicyandimide curing agent, a tertiary curing agent, and water for controlling the total percent of nonvolatiles. The resins are thereafter cured by drying.

According to another preferred embodiment of the invention, the coating step is carried out by padding the resin system onto the fabric.

### BRIEF DESCRIPTION OF THE DRAWINGS

Some of the objects of the invention have been set forth above. Other objects and advantages of the invention will appear as the invention proceeds when taken in conjunction with the following drawings, in which:

FIG. 1 is a schematic perspective view of a reverse osmosis element having a reverse osmosis membrane in accordance with the invention thereon;

FIG. 2 is a schematic cross-sectional view of the reverse osmosis element shown in FIG. 1; and

FIG. 3 is a greatly-enlarged fragmentary cross-sectional view of the reverse osmosis element showing a flow pattern for the liquid being processed.

### DESCRIPTION OF THE PREFERRED EMBODIMENT AND BEST MODE

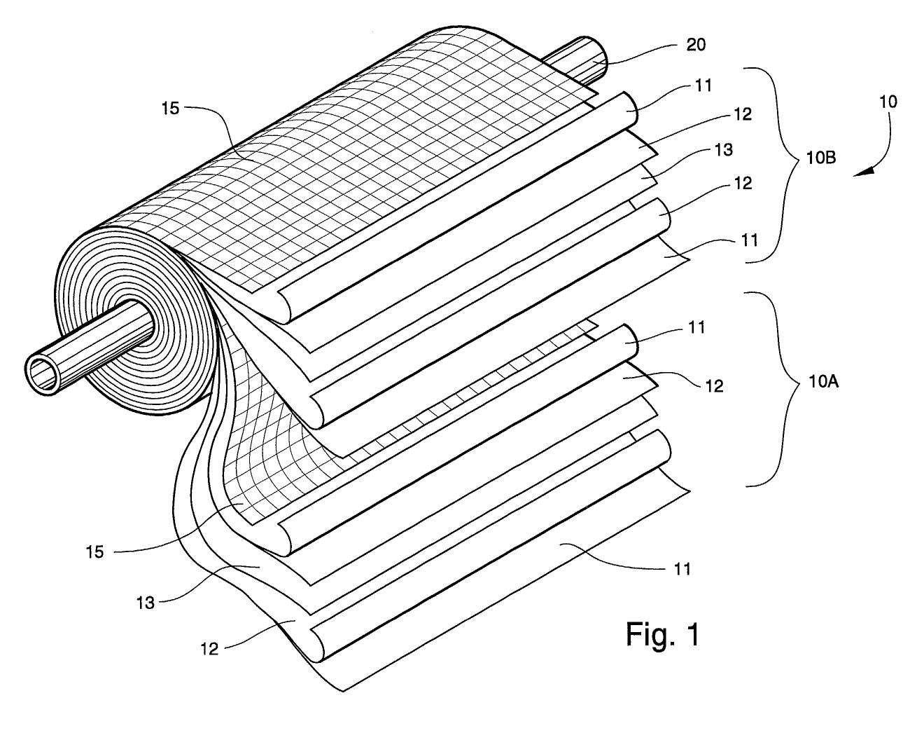

Referring now specifically to the drawings, a reverse osmosis element on which is used a permeate carrier according to the present invention is illustrated in FIG. 1 and shown generally at reference numeral 10. As noted above, the roll 10 may contain numerous spiral-wound layers which collectively make up a usable reverse osmosis filter. As shown in FIG. 1, the roll 10 for purposes of illustration shows two assemblies 10A, 10B, each of which include filter membranes 11, membrane backings 12, and a permeate carrier 13 according to the invention, all adhered together by an adhesive. A mesh spacer 15 separates the assemblies 10A, 10B, and multiple like assemblies which make up an entire reverse osmosis element 10. The reverse osmosis element 10 is carried on a perforated permeate tube 20, which, in turn, is positioned in a pressure vessel assembly, including clamps and end caps (not shown).

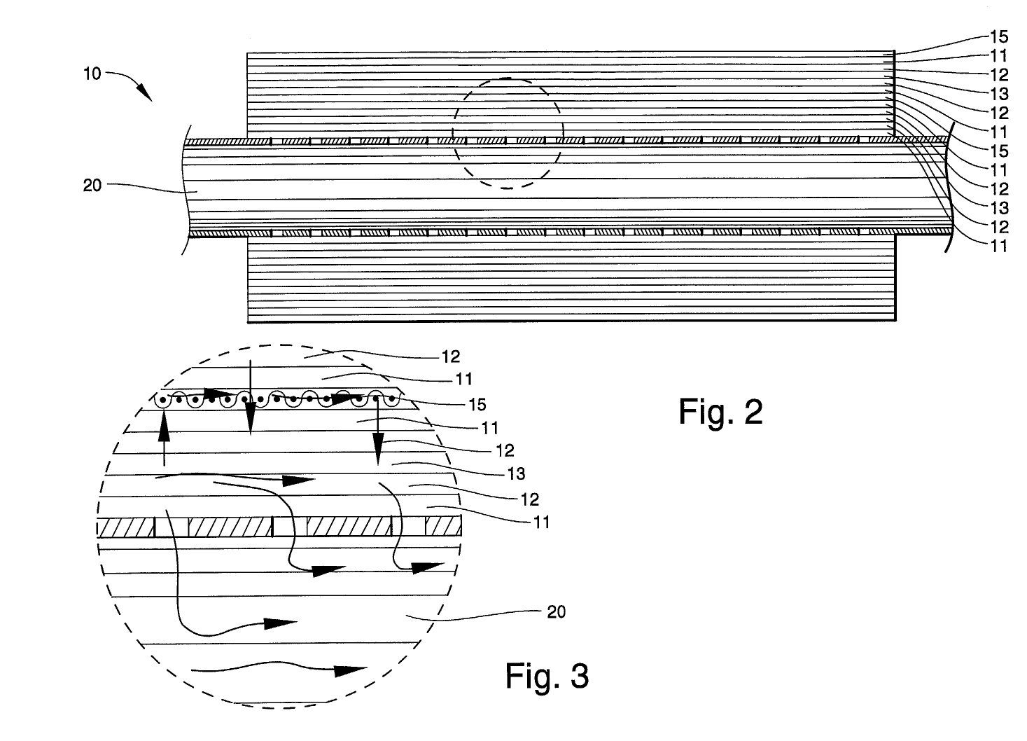

FIG. 2 shows in schematic form a configuration of the assemblies 10A, 10B on the permeate tube 20.

FIG. 3 is a magnified section of the cross-section shown in FIG. 2, showing the first wraps of the assemblies. A typical dimension between between membranes 11 is 0.030 inches (0.76 mm). The arrows indicate the flow of, for example, pure water that passes through successive membranes and spirals through the reverse osmosis element 10 to the permeate tube 20.

The invention is practiced in accordance with the following procedures:

### Components

1. Tricot Knit Polyester Fabric

2. Resolution Performance Products Epoxy Resin Product Codes: RSW-301 1and RSW-2801. (The two stated resins are currently named as research products, the product names may change as they become commercialized)

3. Dicyandiamide curing agent.

4. EPI-CURE 3253 Tertiary Amine curing agent.

5. Base Formulation: Non-fouling fabric can be produced using RSW-3011 or RSW-2801. Both resins contain an average of 56% nonvolatile materials. The base formulation for producing the non-fouling product requires the use of 4.7-6.5 parts per hundred resin of dicyandiamide and 1.5 parts per hundred resin of EPI-CURE 3253. Using this base formulation we can change the percent add-on by adding water to control the total percent of nonvolatile materials in the mix.

### Fabrication

6. Tricot Knit Polyester fabric is dipped in a tank containing the non-fouling mixture. The excess epoxy is squeezed off as the fabric travels between two pressure controlled pad rollers. The fabric is then carried through 4 ovens where the moisture is dryed off and the epoxy resin is cured.

Frame Settings

| Pad Pressure Settings: | 60/60 psi. | | |
|---|---|---|---|
| Tenter Frame Speeds: | 10-20 yards per minute. | | |
| Tenter Frame Temperatures: | Zone 1- | 375° F. | ±10° F. |
| | Zone 2- | 425° F. | ±10° F. |
| | Zone 3- | 425° F. | ±10° F. |
| | Zone 4- | 425° F. | ±10° F. |

### Preferred Procedure for Mixing Filter Components

1. Add 10 gallons of room temperature water to mixing tank.

2. Pre-heat at least 25 gallons of water to near the boiling point of water. Temperature of the water should be at least 200° F.

3. Divide required amount of dicyandiamide into two to three 5 gallon buckets. It is best not to exceed more than 7 pounds of dicyandiamide per 5 gallon bucket.

4. Pump Epoxy Resin dispersion from drum to mixing tank with mixer on. Whenever dispersion is in mixing tank, the stirrer or mixer should be kept on.

5. Fill each of the 5 gallon buckets containing the dicyandiamide with the 200° F. water. Stir each bucket until all dicyandiamide is dissolved. It is essential that all the dicyandiamide be dissolved before adding to the dispersion.

6. Pour the correct amount of EPI-CURE Curing Agent 3253 into one or more of the 5 gallon buckets with the hot water and dissolved dicyandiamide and mix well.

7. Pour the aqueous dicyandiamide solution from the three 5 gallon buckets into the empty drum and mix well.

8. Pump the aqueous dicyandiamide solution into the mixer.

9. Add the remaining water to the mixer. This can be room temperature water.

10. Mix for 30 minutes to allow dicyandiamide to mix with epoxy resin before transferring to dip tank for use.

### Procedure to Determine the Amount of Dicyandiamide (dicy) and Tertiary Amine Curing A-gent (epi-cure 3253) per mix

1 . (Net Weight of drum)×(Percent solids of resin)=Weight of resin.

2. (Dicyandiamide parts per hundred resin)(phr))×(Weight of resin)=Amount of Dicyandiamide per mix.

3. (EPT-Cure 3253 parts per hundred resin)×(Weight of resin)=Amount of Epi-Cure 3253 per mix.

### Procedure to Determine the Amount of Water Needed per Mix to Achieve the Desired Percent Add-on

1. (Total weight of resin)+(weight of dicyandiamide)+(weight of EPI-CURE 3253)=Total weight of solids.

2. (Total weight of solids)(Target percent of nonvolatile material (NW))=Total water weight.

3. (Total water weight)−[(Net weight of drum)+(Weight of Dicyandiamide)+(Weight of EPI-CURE 3253)]=Pounds of water per mix.

4. (Pounds of water)(8.33)=Total gallons of water needed.

### Instructions for Determining Membrane Flux Loss

1. Pre-test

1.1 Cut out two circular samples of membrane so that the two circles are side by side across the membrane roll. Avoid touching the center of the samples as much as possible.

1.2 Identify one membrane sample as “Test” while identifying the second membrane sample as “Control.”

1.3 Cut out one circular filter sample (same size as membrane samples) to be used later with the Test membrane sample.

2. Test

2.1 Insert the membrane samples into the test cells identified as “Test” and “Control.”

2.2 Fill the test unit tank with enough cool and clean water to reach the thermometer immersion line.

2.3 Adjust the water temperature as needed by adding clean ice or clean warm water to the test unit tank.

2.4 Turn on the test unit and allow to run for approximately 60 minutes.

2.5 After the test unit runs for approximately 60 minutes, examine the unit for air bubbles. If there are no air bubbles disconnect test lines and allow water to flow into two separate graduated cylinders for exactly 10 minutes. Each cylinder is identified as “Test” and “Control.”

2.6 Remove test lines and record the meniscus water level of the test cylinder and control cylinder.

2.7 Remove the two membrane samples from the test unit.

2.8 Place the pre-cut filter sample on the smooth side of the membrane “Test” sample. Place the membrane “Test” sample (with filter sample) and the membrane “Control” sample into two separate beakers. Fill the beakers with hot deionized water and allow to soak for exactly 15 minutes.

2.9 After 15 minutes remove the samples from their beakers and thoroughly rinse the samples with clean, cool water.

2.10 Discard the filter sample and place each membrane sample back into their respective test cells.

2.11 Adjust the water temperature as necessary.

2.12 Start the test unit and allow to run for 30 minutes. After 30 minutes examine the unit for air bubbles. If there are no air bubbles disconnect the test lines and allow water to flow into two separate graduated cylinders for exactly 1 0 minutes.

2.13 Remove test lines and record the meniscus water level of the test cylinder and control cylinder.

3. Calculating Flux

3.1 For cell one, subtract the final flow from the initial flow. Divide that number by the initial flow. This gives the cell flux. Do the same for cell two.

3.2 Subtract cell two's flux from cell one's flux to get the adjusted flux. This is the flux loss caused by the addition of the fabric with hot water flux subtracted out.

3.3 Average three adjusted flux's from three tests to get the average adjusted flux loss.

Formulation Amounts for Coating 25% and 16% Tricot Permeate Carrier.
Formulation 25% Weight Add-on

| | Part per | | | |
|---|---|---|---|---|
| | Hundred | | Component, | |
| Component | Resin | Pounds | Lb./Gallon | Gallons |
| RSW-3011 | | 450 | 9.15 | 49.2 |
| (59.6% NVM) | | | | |
| Dicyandiamide* | 4.7 | 12.6 | 5 | 2.5 |
| EPI-Cure* | 1.5 | 4.0 | 8.1 | 0.49 |
| Curing Agent | | | | |
| 3253 | | | | |
| Water | | 371 | 8.33 | 44.5 |
| TOTAL | 34.0% NVM | 837.6 | | 96 |

Formulation 16% Weight Add-on

| | Part per | | | |
|---|---|---|---|---|
| | Hundred | | Component, | |
| Component | Resin | Pounds | Lb./Gallon | Gallons |
| RSW-3011 | | 450 | 9.15 | 49.2 |
| (59.6% NVM) | | | | |
| Dicyandiamide* | 4.7 | 12.6 | 5.0 | 2.5 |
| EPI-Cure* | 1.5 | 4.0 | 8.1 | .49 |
| Curing Agent | | | | |
| 3253 | | | | |
| Water | | 745.4 | 8.33 | 89.5 |
| TOTAL | 23.5% NVM | 1,212.0 | | 141.70 |

NVM = Non-volatile Materials or percent solids.
*Measure the Epi-Cure and Dicy by pounds and water in gallons.

A non-fouling epoxy resin system for the permeate carrier of a reverse osmosis element is described above. Various details of the invention may be changed without departing from its scope. Furthermore, the foregoing description of the preferred embodiment of the invention and the best mode for practicing the invention are provided for the purpose of illustration only and not for the purpose of limitation--the invention being defined by the claims.

I claim:

1. A fouling-resistant permeate carrier for a reverse osmosis element, comprising:
(a) a tricot or simplex knitted fabric;
(b) a resin system coated onto the knitted fabric, said resin system comprising:
(i) a bisphenol-A/epichlorohydrin-based epoxy resin dispersion;
(ii) a low molecular weight solid epoxy resin derived from a liquid epoxy
resin, bisphenol-A, and a polymeric solid epoxy resin possessing an average epoxide group functionality of 8;
(iv) a dispersant;
(v) a dicyandimide curing agent;
(vi) a tertiary curing agent; and
(vii) water for controlling the total percent of nonvolatiles.

2. A fouling-resistant permeate carrier for a reverse osmosis element according to claim 1, wherein the dicyandimide comprises 4.7-6.5 parts per hundred dicyandiamide and 1.5 parts per hundred of the tertiary curing agent.

3. A fouling-resistent permeate carrier for a reverse osmosis element according to claim 1, wherein the low-molecular weight solid epoxy resin and the polymeric solid epoxy resin each contain an average of 56 percent nonvolatile materials.

4. A fouling-resistant permeate carrier for a reverse osmosis element according to claim 1.

5. A method of forming a fouling-resistant permeate carrier for a reverse osmosis element, comprising the steps of:
(a) providing a tricot knitted fabric;
(b) coating a resin system onto the knitted fabric, said resin system comprising:
(i) a bisphenol-A/epichlorohydrin-based epoxy resin dispersion;
(ii) a low molecular weight solid epoxy resin derived from a liquid epoxy resin, bisphenol-A, and a polymeric solid epoxy resin possessing an average epoxide group functionality of 8;
(iii) a dispersant;
(iv) a dicyandimide curing agent;
(v) a tertiary curing agent; and
(vi) water for controlling the total percent of nonvolatiles.
(c) curing the resins by drying.

6. A method of forming a fouling-resistant permeate carrier for a reverse osmosis element according to claim 5, wherein the coating step is carried out by padding the resin system onto the fabric.
